(19) United States
(12) Patent Application Publication
(10) Pub. No.: US 2012/0274776 A1
(43) Pub. Date: Nov. 1, 2012

(54) FAULT TOLERANT BACKGROUND MODELLING

(75) Inventors: Amit Kumar Gupta, Liberty Grove (AU); Xin Yu Liu, Marsfield (AU); Jeroen Vendrig, Liberty Grove (AU); Veena Murthy Srinivasa Dodballapur, Artarmon (AU)

(73) Assignee: CANON KABUSHIKI KAISHA, Tokyo (JP)

(21) Appl. No.: 13/455,714

(22) Filed: Apr. 25, 2012

(30) Foreign Application Priority Data
Apr. 29, 2011 (AU) 2011201953

(51) Int. Cl. H04N 17/00; G06K 9/62; H04N 7/18

(52) U.S. Cl. 348/159; 382/103; 348/E07.085; 348/E17.002

(57) ABSTRACT

Disclosed herein are a system and method for detecting tampering of a first camera in a camera network system, wherein the first camera is adapted to capture a portion of a scene in a field of view of the first camera. The method detects an occlusion of the scene in the field of view of the first camera and changes a field of view of a second camera to overlap with the field of view of the first camera. The method determines a difference between an image captured by the second camera of the changed field of view and a set of reference images relating to the field of view of the first camera. The method then detects tampering of the first camera based on the difference exceeding a predefined threshold.

### REFERENCE TO RELATED PATENT APPLICATION

This application claims the benefit under 35 U.S.C. §119 of the filing date of Australian Patent Application No. 2011201953, filed Apr. 29, 2011, hereby incorporated by reference in its entirety as if fully set forth herein.

### TECHNICAL FIELD

The present disclosure relates generally to video processing and, in particular, to detecting tampering of a camera within a camera network and continuing the separation of foreground objects from a background at the location of the tampered camera.

### BACKGROUND

Video cameras, such as Pan-Tilt-Zoom (PTZ) cameras, are omnipresent nowadays, and are often utilised for surveillance purposes. The cameras capture more data (video content) than human viewers can process. Hence, there is a need for automatic analysis of video content. The field of video analytics addresses this need for automatic analysis of video content. Video analytics is typically implemented in hardware or software, or a combination thereof. The functional component for performing the video analytics may be located on the camera itself, or on a computer or a video recording unit connected to the camera.

A commonly practised technique in video analytics, regardless of how the video analytics are implemented, is the separation of video content into foreground objects and a background scene by comparing the input frame with a scene model. The scene model has historical information about the scene, such as the different positions of a door in the scene at different times in past. Foreground/background separation is important, since foreground/background separation functions as an enabling technology for applications such as object detection and tracking. The term “foreground object” refers to a transient object in the scene. The remaining part of the scene is considered to be a background region, even if the remaining part of the scene contains movement. Such movement may include, for example, swaying of trees or rustling of leaves.

Video surveillance of locations is commonly achieved by using single or multiple cameras. At locations where one or more cameras are installed, events such as loitering, abandoned objects, intrusion, people or objects falling down, etc. are monitored. Video analytics is used to detect such events, so that alarms can be raised to communicate that these events have occurred.

As the popularity of video analytics increases, surveillance systems are increasingly dependent on video analytics to function reliably for long periods of time. Further, automatic camera tamper detection and contingency measures built into the surveillance system are important to ensure continued surveillance of a field of view of a tampered camera with another camera. The term “tamper” refers to either obscuring or vandalising the field view of a camera to diminish or completely remove the effective surveillance coverage of that camera. There are various known technologies to detect tampering of a camera and to continue to perform surveillance.

One way of detecting tampering of a camera is by comparing reference images of the scene with images or portions of images obtained from the field of view of the camera. In this case, tampering of the camera is detected when there is no match between any of the reference images and images or portions of images in the field of view of the camera. However, a disadvantage is that this technique does not differentiate between the tampering of the camera and a genuine object temporarily blocking the view under surveillance.

Another way of detecting tampering of a camera and providing continuity of surveillance is by duplicating camera sensors at each site under surveillance. In this configuration, each of the duplicated sensors constantly communicates and verifies a tamper status of each other. The disadvantage of this approach is the added cost in hardware which can be quite significant and prohibitively expensive for large installations.

Thus, there is a need to improve the tolerance of a camera network system to such tampering attacks.

### SUMMARY

It is an object of one or more embodiments of the present disclosure to overcome substantially, or at least ameliorate, one or more disadvantages of existing arrangements.

The present disclosure provides a method of detecting tampering of a camera by using a second camera. A second camera is selected to change its field of view to overlap with the field of view of the first camera and a difference score is computed to confirm a tamper situation at the field of view of the first camera. Upon confirming tampering of the first camera, the scene model of the first camera is partially reused by the second camera for continued object detection.

According to a first aspect of the present disclosure, there is provided a method for detecting tampering of a first camera in a camera network system, wherein the first camera is adapted to capture a portion of a scene in a field of view of the first camera. The method includes the steps of: detecting an occlusion of the scene in the field of view of the first camera; changing a field of view of a second camera to overlap with the field of view of the first camera; determining a difference between an image captured by the second camera of the changed field of view and a set of reference images relating to the field of view of the first camera; and detecting tampering of the first camera based on the difference exceeding a predefined threshold.

According to a second aspect of the present disclosure, there is provided a method for detecting a foreground object in an image sequence. The method detects a foreground object in a first field of view of a first camera, using a scene model associated with the first field of view of the first camera, and detects an event at the first camera, based on the detected foreground object. The method transfers to a second camera a background model associated with the first field of view of the first camera and calibration information associated with the first camera and determines a reusable part of the background model associated with the first field of view of the first camera, based on the calibration information associated with the first camera. The method changes a second field of view of the second camera to overlap the first field of view of the first camera and detects a foreground object in the changed field of view of the second camera, based on the determined reusable part of the background model.

According to a third aspect of the present disclosure, there is provided a camera network system for monitoring a scene, the system including: a first camera having a first field of view; a second camera having a second field of view; a memory for storing a background model associated with a portion of a scene corresponding to the first field of view of the first camera; a storage device for storing a computer program; and a processor for executing the program. The program includes code for performing the method steps of: detecting an occlusion of the scene in the first field of view of the first camera; changing the second field of view of the second camera to overlap with the first field of view of the first camera; determining a difference between an image captured by the second camera of the changed field of view and a set of reference images relating to the first field of view of the first camera; and detecting tampering of the first camera based on the difference exceeding a predefined threshold.

According to a fourth aspect of the present disclosure, there is provided a method for detecting tampering of a first camera in a camera network system, wherein the first camera is adapted to capture a portion of a scene in a field of view of the first camera. The method includes the steps of: detecting an occlusion of the scene in the field of view of the first camera; changing a field of view of a second camera to overlap with the field of view of the first camera; determining a difference between an image captured by the second camera of the changed field of view and a reference image relating to the field of view of the first camera; and detecting tampering of the first camera based on the difference exceeding a predefined threshold.

According to another aspect of the present disclosure, there is provided a method for detecting tampering of a first camera in a camera network system, the first camera being adapted to capture a scene in a first field of view, said method comprising: detecting an occlusion of the scene in the first field of view; changing a second field of view of a second camera to overlap with the first field of view of the first camera in response to the detected occlusion; and transferring a background model of the scene in the first field of view of the first camera to the second camera.

According to another aspect of the present disclosure, there is provided an apparatus for implementing any one of the aforementioned methods.

According to another aspect of the present disclosure, there is provided a computer program product including a computer readable medium having recorded thereon a computer program for implementing any one of the methods described above.

Other aspects of the present disclosure are also disclosed.

### BRIEF DESCRIPTION OF THE DRAWINGS

At least one embodiment of the present invention will now be described with reference to the following drawings, in which:

FIG. 1 is a functional block diagram of a network camera, upon which foreground/background separation is performed;

FIG. 2 is a block diagram of two network cameras monitoring respective fields of view in a scene;

FIG. 3A shows a scenario in which the first camera is tampered;

FIG. 3B shows a scenario in which the first camera is not tampered;

FIG. 4 is a functional diagram that shows overlapping fields of view between first and second cameras;

FIG. 5 is a schematic flow diagram that shows the overall process of tamper detection at a camera;

FIG. 6 is a schematic flow diagram that shows the process of determining if a first camera has been tampered, by computing a difference score;

FIG. 7 is a schematic flow diagram that shows the process of converting the background model of the first camera to an image;

FIG. 8 is a schematic flow diagram that shows the process of the second camera continuing video recording at the situation of first camera being tampered;

FIG. 9 is a schematic flow diagram that shows the process of determining a reusable part of the scene model from first camera;

FIG. 10 is a block diagram of a scene model consisting of local element models;

FIG. 11A is a block diagram that shows the setup of a network of four cameras, each of which monitors a non-overlapping field of view in a scene;

FIG. 11B is a schematic flow diagram that shows the process of camera selection when one of the cameras shown in FIG. 11A has detected occlusion; and

FIGS. 12A and 12B form a schematic block diagram of a general purpose computer system upon which arrangements described can be practised.

### DETAILED DESCRIPTION INCLUDING BEST MODE

Where reference is made in any one or more of the accompanying drawings to steps and/or features that have the same reference numerals, those steps and/or features have for the purposes of this description the same function(s) or operation(s), unless the contrary intention appears.

One way of avoiding duplication of camera sensors is to set up a network of cameras and pass object information among those cameras. When tampering of a camera in such a network is detected, a second camera suitably alters its field of view, for example by an operator, to take over object detection of the field of view of the tampered camera. However, since the second camera does not have historical information of the field of view of the tampered camera, false object detections will occur until a scene model is correctly initialised. The correct initialisation of the scene model can take a long time, depending on the foreground activity in the scene. This means the video analytics are not working at the time when it is most critical, which is the time at which a possible tampering attack is detected.

The present disclosure provides a method and system for detecting tampering of a video camera. The method detects occlusion of a scene in a first field of view of a first video camera. An occlusion can be anything that blocks all or a portion of a field of view. One way for detecting occlusion is when foreground object detection for a scene exceeds a predefined occlusion threshold. The method then changes a field of view of a second camera to overlap with the first field of view of the first camera and compares an image captured by the second camera of the changed field of view with a set of reference images relating to the first field of view of the first camera. The set of reference images may be one or more reference images derived from a scene model associated with the scene. These reference images are constructed from the element models in the scene model of the first camera. In another implementation of the present embodiment, the reference images are the sequence of images previously captured by the first camera. The method detects tampering of the first camera when a difference between the image captured by the second camera and the set of reference images exceeds a predetermined difference threshold. In another implementation of the present embodiment, the processor unit 105 detects tampering of the first camera when a difference between the image captured by the second camera and a reference image exceeds a predetermined difference threshold.

In one arrangement, the scene model is stored on the first camera. In another arrangement, the scene model is stored remotely from the first camera, such as on a server or database coupled to each of the first camera and the second camera.

According to one aspect, the present disclosure provides a camera network system for monitoring a scene. The camera network includes a plurality of cameras, wherein each camera has an associated field of view for capturing images of respective portions of the scene that is being monitored. The cameras are coupled to each other via a network. In particular, the system includes a first camera having a first field of view and a second camera having a second field of view. The system also includes a memory for storing a background model associated with a portion of the scene corresponding to said first field of view of said first camera. The system further includes a storage device for storing a computer program and a processor for executing the program.

The program includes code for performing the method steps of: detecting an occlusion of the scene in the first field of view of the first camera; changing said second field of view of said second camera to overlap with the first field of view of the first camera; determining a difference between an image captured by the second camera of said changed field of view and a set of reference images relating to said first field of view of said first camera; and detecting tampering of said first camera based on said difference exceeding a predefined threshold.

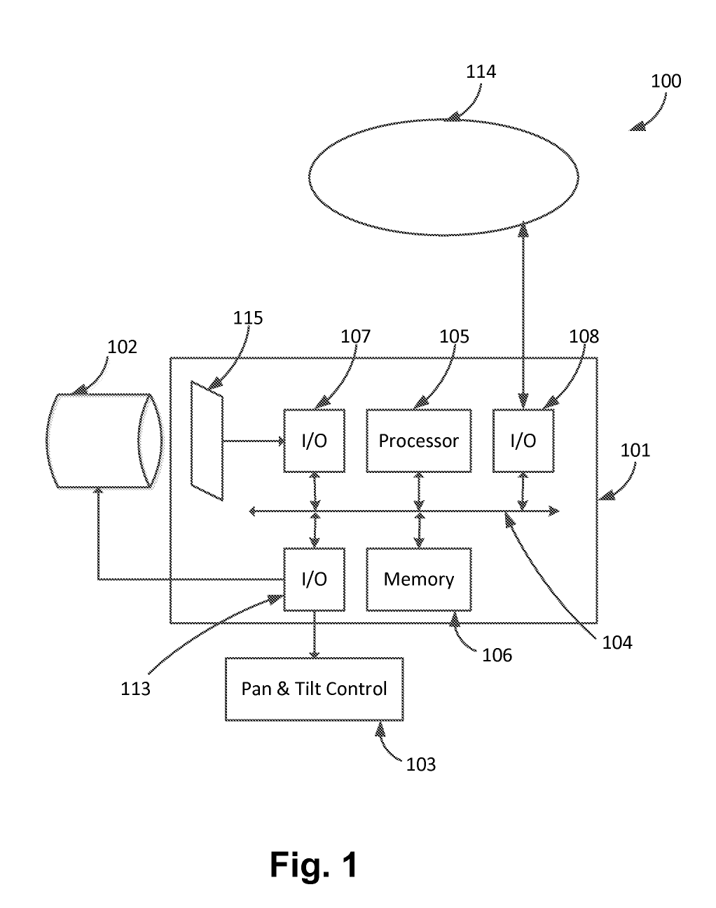

In one arrangement, each camera is a network camera, as described below with reference to FIG. 1. In one arrangement, the system includes a server coupled to the network for controlling the networked cameras, wherein the server includes the storage device and the processor.

The present disclosure further provides a method and system for maintaining surveillance of a field of view of a camera, once tampering of the camera has been detected, by transferring to a second camera a background model associated with the field of view. The method also transfers calibration information to the second camera and determines a reusable part of the scene model of the field of view of the tampered camera, based on the calibration information.

In one arrangement, the calibration information is stored on the first camera. In another arrangement, the calibration information is stored remotely from the first camera, such as on a server or database coupled to each of the first camera and the second camera. The calibration information may include, for example, a physical location of a camera and a set of parameters for that camera.

FIG. 1 shows a functional block diagram of a network camera 100, upon which foreground/background separation is performed. The camera 100 is a pan-tilt-zoom camera (PTZ) comprising a camera module 101, a pan and tilt module 103, and a lens system 102. The camera module 101 typically includes at least one processor unit 105, a memory unit 106, a photo-sensitive sensor array 115, a first input/output (I/O) interface 107 that couples to the sensor array 115, a second input/output (I/O) interface 108 that couples to a communications network 114, and a third input/output (I/O) interface 113 for the pan and tilt module 103 and the lens system 102. The components 107, 105, 108, 113 and 106 of the camera module 101 typically communicate via an interconnected bus 104 and in a manner which results in a conventional mode of operation known to those in the relevant art.

The camera 100 is used to capture video frames, also known as new input images. A sequence of captured video frames may also be referred to as a video sequence or an image sequence. A video frame represents the visual content of a scene appearing in the field of view of the camera 100 at a point in time. Each frame captured by the camera 100 comprises one or more visual elements. A visual element is defined as a region in an image sample. In an exemplary arrangement, a visual element is an 8 by 8 block of Discrete Cosine Transform (DCT) coefficients as acquired by decoding a motion-JPEG frame. In the arrangement, blocks are non-overlapping. In another arrangement, blocks overlap. In other arrangements, a visual element is one of: a pixel, such as a Red-Green-Blue (RGB) pixel; a group of pixels; or a block of other transform coefficients, such as Discrete Wavelet Transformation (DWT) coefficients as used in the JPEG-2000 standard. The colour model is typically YUV, where the Y component represents the luminance, and the U and V components represent the chrominance.

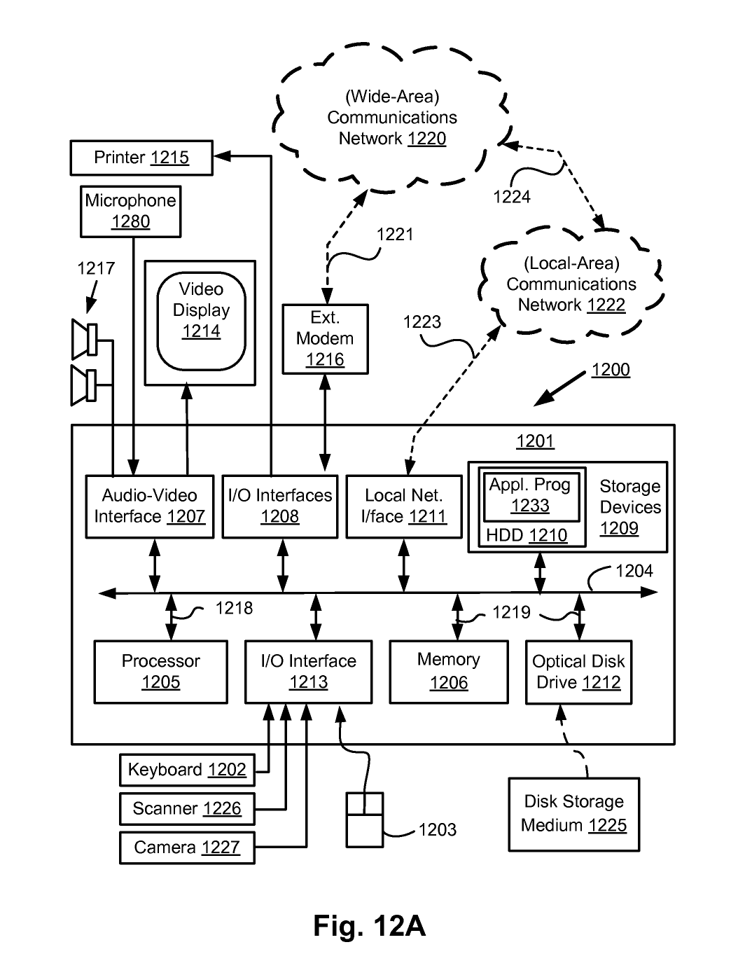

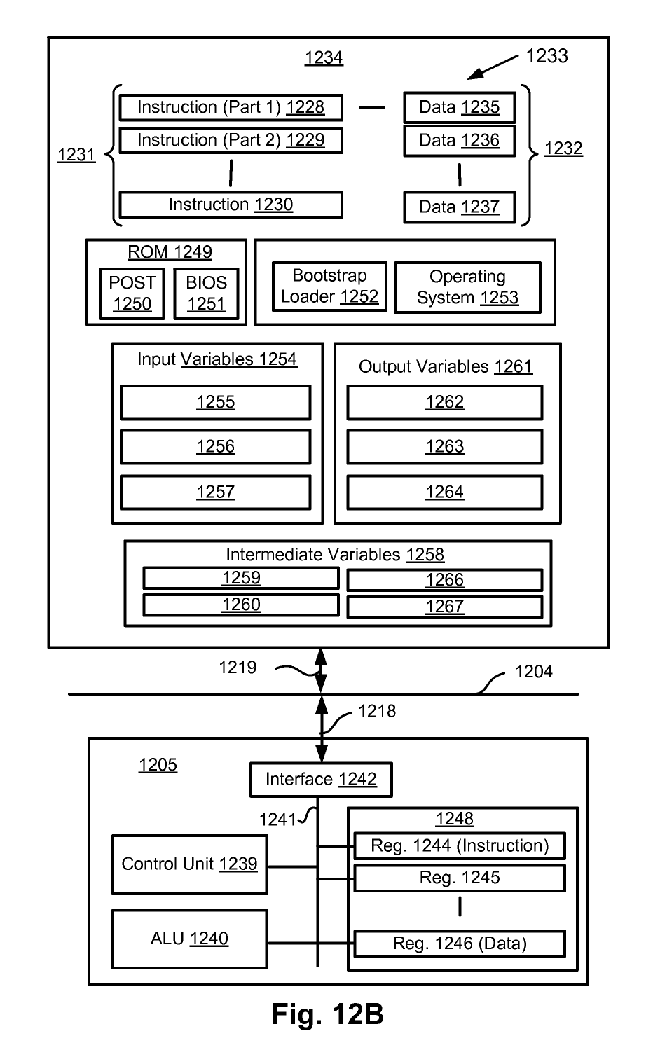

FIGS. 12A and 12B depict a general-purpose computer system 1200, upon which the is various arrangements described can be practised. In particular, the general purpose computer system 1200 can be utilised to effect one or more of the networked cameras 260, 270 and the server 285 coupled to the network 290.

As seen in FIG. 12A, the computer system 1200 includes: a computer module 1201; input devices such as a keyboard 1202, a mouse pointer device 1203, a scanner 1226, a camera 1227, and a microphone 1280; and output devices including a printer 1215, a display device 1214 and loudspeakers 1217. An external Modulator-Demodulator (Modem) transceiver device 1216 may be used by the computer module 1201 for communicating to and from a communications network 1220 via a connection 1221. The communications network 1220 may be a wide-area network (WAN), such as the Internet, a cellular telecommunications network, or a private WAN. Where the connection 1221 is a telephone line, the modem 1216 may be a traditional “dial-up” modem. Alternatively, where the connection 1221 is a high capacity (e.g., cable) connection, the modem 1216 may be a broadband modem. A wireless modem may also be used for wireless connection to the communications network 1220.

The computer module 1201 typically includes at least one processor unit 1205, and a memory unit 1206. For example, the memory unit 1206 may have semiconductor random access memory (RAM) and semiconductor read only memory (ROM). The computer module 1201 also includes an number of input/output (I/O) interfaces including: an audio-video interface 1207 that couples to the video display 1214, loudspeakers 1217 and microphone 1280; an I/O interface 1213 that couples to the keyboard 1202, mouse 1203, scanner 1226, camera 1227 and optionally a joystick or other human interface device (not illustrated); and an interface 1208 for the external modem 1216 and printer 1215. In some implementations, the modem 1216 may be incorporated within the computer module 1201, for example within the interface 1208. The computer module 1201 also has a local network interface 1211, which permits coupling of the computer system 1200 via a connection 1223 to a local-area communications network 1222, known as a Local Area Network (LAN). As illustrated in FIG. 12A, the local communications network 1222 may also couple to the wide network 1220 via a connection 1224, which would typically include a so-called “firewall” device or device of similar functionality. The local network interface 1211 may comprise an Ethernet™ circuit card, a Bluetooth™ wireless arrangement or an IEEE 802.11 wireless arrangement; however, numerous other types of interfaces may be practised for the interface 1211.

The I/O interfaces 1208 and 1213 may afford either or both of serial and parallel connectivity, the former typically being implemented according to the Universal Serial Bus (USB) standards and having corresponding USB connectors (not illustrated). Storage devices 1209 are provided and typically include a hard disk drive (HDD) 1210. Other storage devices such as a floppy disk drive and a magnetic tape drive (not illustrated) may also be used. An optical disk drive 1212 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 1200.

The components 1205 to 1213 of the computer module 1201 typically communicate via an interconnected bus 1204 and in a manner that results in a conventional mode of operation of the computer system 1200 known to those in the relevant art. For example, the processor 1205 is coupled to the system bus 1204 using a connection 1218. Likewise, the memory 1206 and optical disk drive 1212 are coupled to the system bus 1204 by connections 1219. Examples of computers on which the described arrangements can be practised include IBM-PC's and compatibles, Sun Sparcstations, Apple Mac™ or alike computer systems.

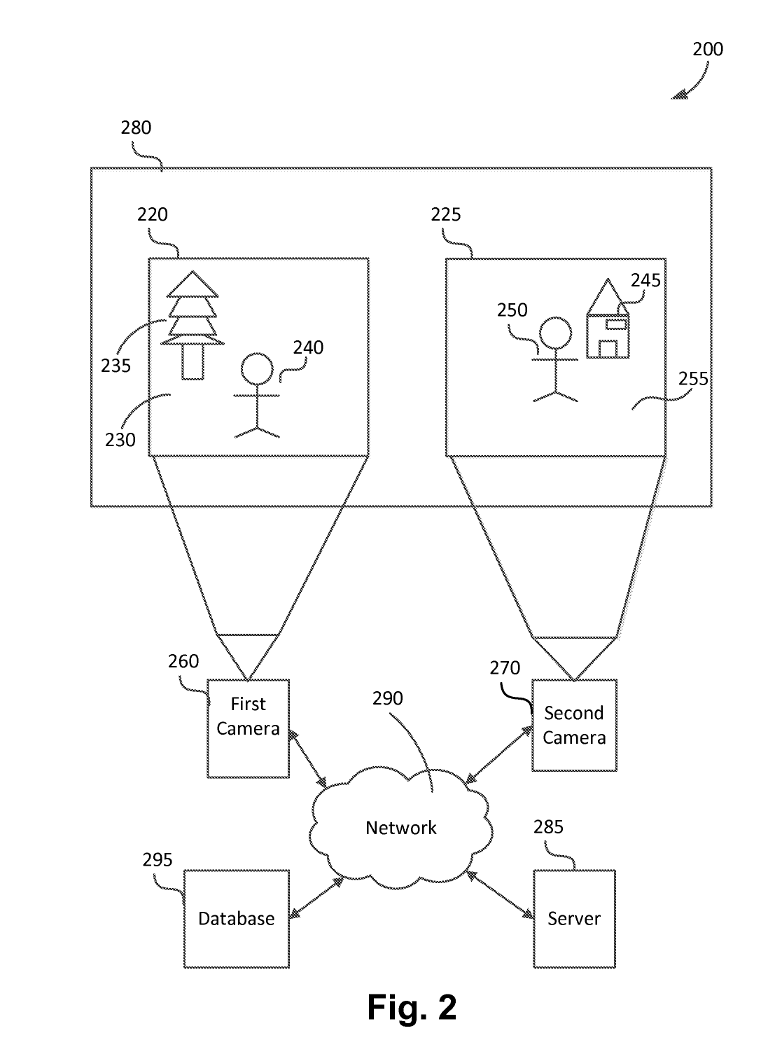

The method of detecting tampering of a camera may be implemented using the computer system 1200 wherein the processes of FIGS. 2 to 11, described herein, may be implemented as one or more software application programs 1233 executable within the computer system 1200. In particular, the steps of the method of detecting tampering and maintaining surveillance of a scene are effected by instructions 1231 (see FIG. 12B) in the software 1233 that are carried out within the computer system 1200. The software instructions 1231 may be formed as one or more code modules, each for performing one or more particular tasks. The software may also be divided into two separate parts, in which a first part and the corresponding code modules performs the tamper detecting methods and a second part and the corresponding code modules manage a user interface between the first part and the user.

The software 1233 is typically stored in the HDD 1210 or the memory 1206. The software is loaded into the computer system 1200 from a computer readable medium, and executed by the computer system 1200. Thus, for example, the software 1233 may be stored on an optically readable disk storage medium (e.g., CD-ROM) 1225 that is read by the optical disk drive 1212. A computer readable medium having such software or is computer program recorded on it is a computer program product. The use of the computer program product in the computer system 1200 preferably effects an apparatus for detecting tampering of a networked camera and maintaining surveillance of a scene.

In some instances, the application programs 1233 may be supplied to the user encoded on one or more CD-ROMs 1225 and read via the corresponding drive 1212, or alternatively may be read by the user from the networks 1220 or 1222. Still further, the software can also be loaded into the computer system 1200 from other computer readable media. Computer readable storage media refers to any non-transitory tangible storage medium that provides recorded instructions and/or data to the computer system 1200 for execution and/or processing. Examples of such storage media include floppy disks, magnetic tape, CD-ROM, DVD, Blu-ray Disc, a hard disk drive, a ROM or integrated circuit, USB memory, a magneto-optical disk, or a computer readable card such as a PCMCIA card and the like, whether or not such devices are internal or external of the computer module 1201. Examples of transitory or non-tangible computer readable transmission media that may also participate in the provision of software, application programs, instructions and/or data to the computer module 1201 include radio or infra-red transmission channels as well as a network connection to another computer or networked device, and the Internet or Intranets including e-mail transmissions and information recorded on Websites and the like.

The second part of the application programs 1233 and the corresponding code modules mentioned above may be executed to implement one or more graphical user interfaces (GUIs) to be rendered or otherwise represented upon the display 1214. Through manipulation of typically the keyboard 1202 and the mouse 1203, a user of the computer system 1200 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 1217 and user voice commands input via the microphone 1280.

FIG. 12B is a detailed schematic block diagram of the processor 1205 and a “memory” 1234. The memory 1234 represents a logical aggregation of all the memory modules (including the HDD 1209 and semiconductor memory 1206) that can be accessed by the computer module 1201 in FIG. 12A.

When the computer module 1201 is initially powered up, a power-on self-test (POST) program 1250 executes. The POST program 1250 is typically stored in a ROM 1249 of the semiconductor memory 1206 of FIG. 12A. A hardware device such as the ROM 1249 storing software is sometimes referred to as firmware. The POST program 1250 examines hardware within the computer module 1201 to ensure proper functioning and typically checks the processor 1205, the memory 1234 (1209, 1206), and a basic input-output systems software (BIOS) module 1251, also typically stored in the ROM 1249, for correct operation. Once the POST program 1250 has run successfully, the BIOS 1251 activates the hard disk drive 1210 of FIG. 12A. Activation of the hard disk drive 1210 causes a bootstrap loader program 1252 that is resident on the hard disk drive 1210 to execute via the processor 1205. This loads an operating system 1253 into the RAM memory 1206, upon which the operating system 1253 commences operation. The operating system 1253 is a system level application, executable by the processor 1205, to fulfil various high level functions, including processor management, memory management, device management, storage management, software application interface, and generic user interface.

The operating system 1253 manages the memory 1234 (1209, 1206) to ensure that each process or application running on the computer module 1201 has sufficient memory in which to execute without colliding with memory allocated to another process. Furthermore, the different types of memory available in the system 1200 of FIG. 12A must be used properly so that each process can run effectively. Accordingly, the aggregated memory 1234 is not intended to illustrate how particular segments of memory are allocated (unless otherwise stated), but rather to provide a general view of the memory accessible by the computer system 1200 and how such is used.

As shown in FIG. 12B, the processor 1205 includes a number of functional modules including a control unit 1239, an arithmetic logic unit (ALU) 1240, and a local or internal memory 1248, sometimes called a cache memory. The cache memory 1248 typically include a number of storage registers 1244-1246 in a register section. One or more internal busses 1241 functionally interconnect these functional modules. The processor 1205 typically also has one or more interfaces 1242 for communicating with external devices via the system bus 1204, using a connection 1218. The memory 1234 is coupled to the bus 1204 using a connection 1219.

The application program 1233 includes a sequence of instructions 1231 that may include conditional branch and loop instructions. The program 1233 may also include data 1232 which is used in execution of the program 1233. The instructions 1231 and the data 1232 are stored in memory locations 1228, 1229, 1230 and 1235, 1236, 1237, respectively. Depending upon the relative size of the instructions 1231 and the memory locations 1228-1230, a particular instruction may be stored in a single memory location as depicted by the instruction shown in the memory location 1230. Alternatively, an instruction may be segmented into a number of parts each of which is stored in a separate memory location, as depicted by the instruction segments shown in the memory locations 1228 and 1229.

In general, the processor 1205 is given a set of instructions which are executed therein. The processor 1105 waits for a subsequent input, to which the processor 1205 reacts to by executing another set of instructions. Each input may be provided from one or more of a number of sources, including data generated by one or more of the input devices 1202, 1203, data received from an external source across one of the networks 1220, 1202, data retrieved from one of the storage devices 1206, 1209 or data retrieved from a storage medium 1225 inserted into the corresponding reader 1212, all depicted in FIG. 12A. The execution of a set of the instructions may in some cases result in output of data. Execution may also involve storing data or variables to the memory 1234.

The disclosed networked camera arrangements use input variables 1254, which are stored in the memory 1234 in corresponding memory locations 1255, 1256, 1257. The networked camera arrangements produce output variables 1261, which are stored in the memory 1234 in corresponding memory locations 1262, 1263, 1264. Intermediate variables 1258 may be stored in memory locations 1259, 1260, 1266 and 1267.

Referring to the processor 1205 of FIG. 12B, the registers 1244, 1245, 1246, the arithmetic logic unit (ALU) 1240, and the control unit 1239 work together to perform sequences of micro-operations needed to perform “fetch, decode, and execute” cycles for every instruction in the instruction set making up the program 1233. Each fetch, decode, and execute cycle comprises:

(a) a fetch operation, which fetches or reads an instruction 1231 from a memory location 1228, 1229, 1230;

(b) a decode operation in which the control unit 1239 determines which instruction has been fetched; and

(c) an execute operation in which the control unit 1239 and/or the ALU 1240 execute the instruction.

Thereafter, a further fetch, decode, and execute cycle for the next instruction may be executed. Similarly, a store cycle may be performed by which the control unit 1239 stores or writes a value to a memory location 1232.

Each step or sub-process in the processes of FIGS. 2 to 11 is associated with one or more segments of the program 1233 and is performed by the register section 1244, 1245, 1247, the ALU 1240, and the control unit 1239 in the processor 1205 working together to perform the fetch, decode, and execute cycles for every instruction in the instruction set for the noted segments of the program 1233.

The method of detecting tampering of a camera may alternatively be implemented in dedicated hardware such as one or more integrated circuits performing the functions or sub functions of detecting occlusion and detecting tampering. Such dedicated hardware may include graphic processors, digital signal processors, or one or more microprocessors and associated memories.

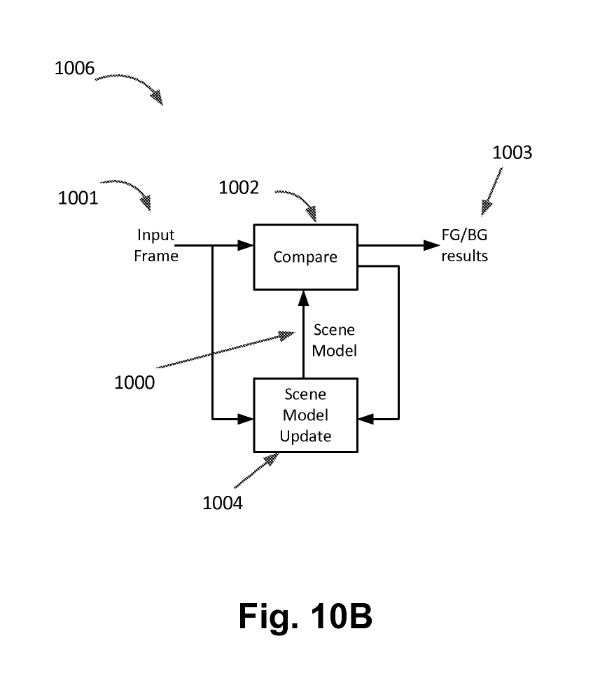

Recent advances in network camera design have provided technology for video analytics, for example video object detection, on the camera itself using processor 105 and memory 106. FIG. 10A is a schematic block diagram representation of a scene model 1000. The scene model 1000 includes multiple element models (block modes or mode models). For each visual element position in the image, there is a corresponding position in the scene model 1000. In the example of FIG. 10A, an exemplary position is element model set 1010, which corresponds to an 8×8 DCT block. The element model set 1010 is a set of element models: Element model 1 1020, Element model 2, . . . , Element model N. Each element model is associated with a plurality of attributes. In this example, the element model 1020 comprises visual information 1030, such as intensity, colour, and texture, as well as temporal information 1050, such as creation time, deletion time (the time or frame at which the element model will be deleted if the element model is not matched anymore), last match time, and hit count. The scene model 1000 is stored in memory 106.

FIG. 10B illustrates one arrangement of an object detection algorithm 1006 that uses a scene model 1000. The object detection algorithm provides an input frame 1001 to each of a Compare module 1002 and a Scene Model Update module 1004. The Compare module 1002 also receives a scene model 1000 from the Scene Model Update module 1004. For object detection, each block within the input image 1001 is compared to all of the stored block modes for the corresponding visual element, as shown by the Compare module 1002. If the compare module 1002 identifies a match between a block of the input image 1001 and an existing element model 1020 in an element model set 1010, the Compare module 1002 sends information relating to the match to the Scene Model Update module 1004 and the Scene Model Update module 1004 updates the matched element model.

In the update process, both visual information 1030 and temporal information 1050 associated with the matched element model are modified. In one arrangement, the visual information 1030 is updated with a learning rate threshold LRₘₐₓ using the approximated median filter method. LRₘₐₓ represents the maximum change allowed for a visual information 1030 per update. In the same arrangement, the temporal information 1050 is updated using the current state of the temporal data, and the current time. More specifically, the match count of the element model is incremented with one hit, until a maximum match count, say 1000 hits, is reached. The deletion time for the element model is increased by a number of frames, say 500 frames. The last match time for the element model is set to the current time.

If no matching block mode is found by the Compare module 1002, then a new block mode is created. If a new block mode or a matched block mode was created at a time within a set period of current time, then the block in the input image is considered to be foreground. A matched block mode that is older than said set period of time is considered to be background. The foreground blocks are connected by using a floodfill algorithm to output, from the Compare module 1002, foreground objects as a mask 1003. The detected foreground regions are further processed depending on the intended application of the network camera. For example, in video surveillance an alarm is raised if a foreground region is detected in a pre-defined area within the frame.

FIG. 2 is a schematic representation of a surveillance system 200 in which network cameras perform video surveillance on a scene 280. The system 200 includes a first camera 260 and a second camera 270, which are two network cameras coupled to a network 290. The system also includes an optional server 285 and a database 295 coupled to the network 290.

In one implementation, each of the first camera 260 and the second camera 270 are cameras that include processors and memory for storing reference images and calibration information. In an alternative implementation, either one or both of the server 285 and the database 295 are used to store: background models relating to portions of the scene 280 corresponding to the respective fields of view of the first camera 260 and the second camera 270; sets of reference images derived from the respective background models; calibration information relating to the first camera 260 and the second camera 270; or any combination thereof. In one arrangement, the server 285 further includes a storage device for storing a computer program and a processor for executing the program, wherein the program controls operation of the surveillance system 200.

Each of the first camera 260 and the second camera 270 may be implemented using the network camera 100 of FIG. 1. The first camera 260 and the second camera 270 perform video surveillance of portions of a scene 280. The first camera 260 captures images from a first field of view 220 and the second camera 270 captures images from a second field of view 225. The first field of view 220 and the second field of view 225 are non-overlapping fields of view in the scene 280. In the first field of view 220 that is captured by the first camera 260, there is a person 240 representing a foreground object and the remaining region of the first field of view 220, including a tree 235, represents a first background region 230. In the second field of view 225 that is captured by the second camera 270, there is a person 250 representing a foreground object and the remaining region of the second field of view 230, including a house 245, represents a second background region 255. A background region is usually spatially connected, but in cases where the foreground splits an image frame in parts, the background region comprises several disjoint parts.

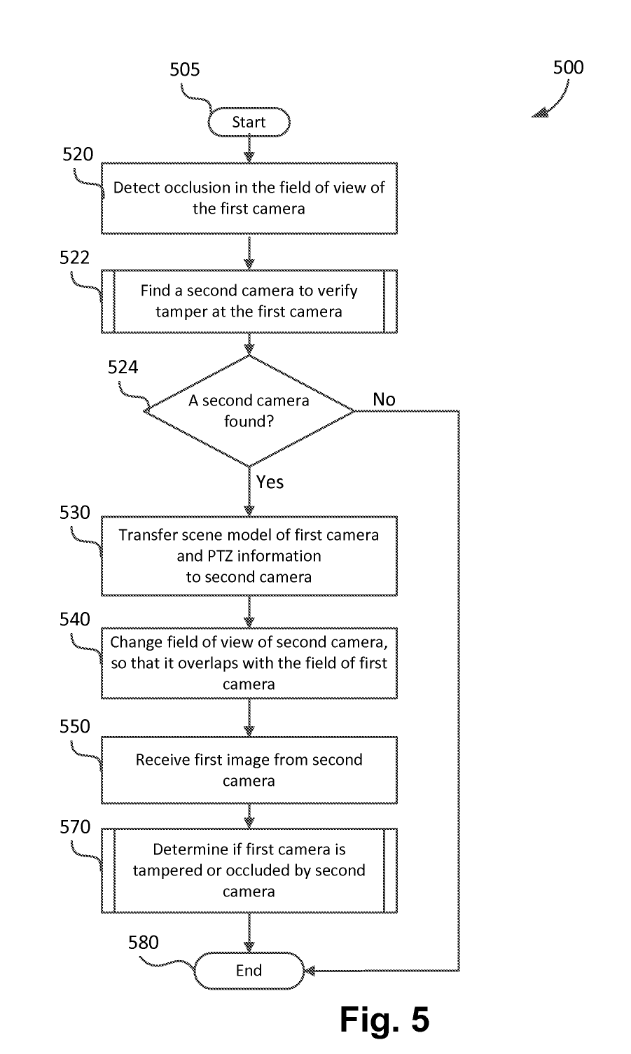

FIG. 5 is a flow diagram illustrating a method 500 of using a second camera in a camera network system to determine if a first camera has been tampered with or occluded. In one embodiment, the method 500 is implemented as one or more code modules of the firmware residing within the memory 106 of the camera system 100 and being controlled in its execution by the processor 105. In an alternative embodiment, the method 500 is implemented using the general purpose computer described with reference to FIGS. 12A and 12B.

As described above, the first camera 260 of FIG. 2 is observing the first field of view 220. Occlusion of the background means that there is something new between the observed background scene 280 and the first camera 260. The occlusion may be a foreground object, such as a pedestrian or a car moving through the scene or even parking. However, the occlusion may also be an intentional attack on the camera 260 and the related surveillance system. Such an attack may be effected, for example, through spray painting of the lens of the camera or by holding a photo of the same scene 280 in front of the first camera 260. An occlusion raises the possibility that the camera 260 is tampered. It is important to distinguish reliably between tamper occlusions and foreground object occlusions. In the exemplary embodiment, occlusion is detected if, for an input frame, the percentage of foreground region detected in the frame is higher than a pre-defined threshold. In one example, the predefined threshold is 70%. In another implementation, the threshold is adaptive. For example, this threshold is the average percentage of foreground region detected in a number of predetermined number N, say 20, of previous frames plus a predefined constant K, say 30%. In another implementation, the captured image is divided into sub-frames, such as, for example, 4 quarters of the captured images, and occlusion is detected if the percentage of foreground detected in any of the pre-defined set of sub-frames is higher than a pre-defined threshold, say 70%.

The method 500 begins at a Start step 505 and proceeds to a step 520, which detects occlusion in the field of view of the first camera. Control then passes to step 552, which attempts to identify another camera among multiple cameras in the camera network to be the candidate for verification of tampering of the first camera. The candidate camera is referred to as the second camera.

Control passes from step 522 to a decision step 524, which evaluates the output of the step 522 and determines whether a second camera was identified. If a second camera was not found, No, the path NO is selected, control passes to an End step 580 and the method 500 terminates. In one embodiment, the camera network system issues a tamper detection alarm with additional information that tampering of the first camera cannot be verified because a suitable second camera is not available.

Returning to step 524, if a second camera is identified in step 522, Yes, the path YES is selected and control passes to step 530. Step 530 selects the second camera and transfers a scene model of the first field of view of the first camera to the selected second camera. If the second camera is selected by the processor 105 in the first camera, the processor 105 of the first camera transfers a scene model 1000 associated with the first field of view of the first camera and the relative PTZ coordinates from the memory 106 of the first camera to the memory 106 in the selected second camera, via the communication network 114. Alternatively, the scene model and PTZ coordinates are transferred from a server or database coupled to, or forming part of, the camera network system, such as the server 285 and database 295 of the system 200.

Control passes from step 530 to a changing step 540, which changes the field of view of the second camera towards the field of view specified in the PTZ information by the first camera. The PTZ information provided by the first camera enables the second camera to change its field of view to overlap with the first field of view of the first camera.

In one implementation, the transfer of the scene model of the first field of view of the first camera to the second camera happens contemporaneously with the changing of the field of view of the second camera in step 540. In another implementation, the second camera receives the scene model 1000 of the first field of view of the first camera and the relative PTZ coordinates after the field of view of the second camera is changed in changing step 540. Due to the different physical locations of the first camera and the second camera, the first field of view of the first camera and the changed field of view of the second camera will generally not match completely. Rather, the method utilises the common, or overlapping, field of view between the first field of view of first camera and the modified field of view of the second camera. In a next step 550, the method 500 captures a first image from the changed field of view of the second camera via the lens 102 by the processor 105.

Control passes from step 550 to tamper determining step 570, which determines if the occlusion at the first camera is due to tampering. Control then passes to step 580 and the method 500 terminates.

The second camera selection step 522 is now explained. In the exemplary embodiment, the information that assists in the selection of a second camera for each camera in the camera network is predetermined and stored within memory 106 of the first camera. The information includes:
1. The camera identification information; and
2. The pan-tilt-zoom coordinates for a candidate camera, such that the selected second camera can be adjusted to have a maximum possible overlapping field-of-view with the first camera.

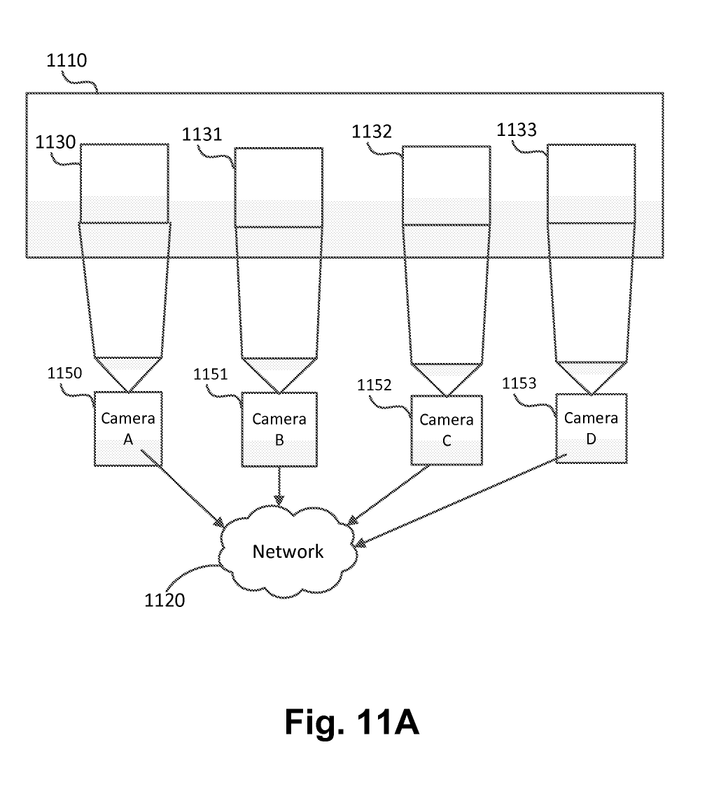

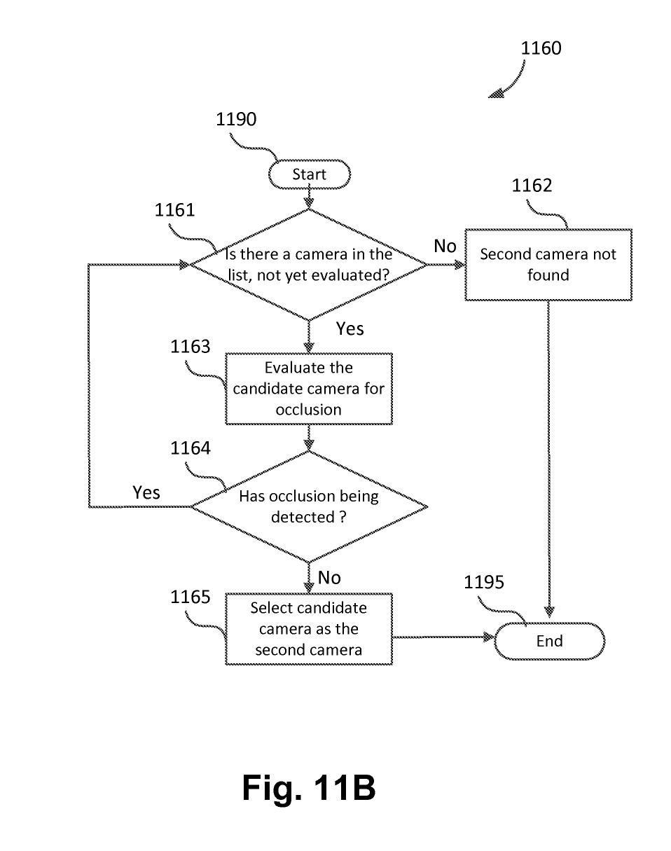

The information is further explained with respect to FIG. 11A, which is a schematic representation of a camera network system. A scene 1110 is the complete scene which is under surveillance. There are 4 cameras in the camera network system: camera A 1150, camera B 1151, camera C 1152, and camera D 1153. Each of the camera A 1150, camera B 1151, camera C 1152, and camera D 1153 is coupled to a network 1120.

Camera A is looking at a first portion 1130 of the scene 1110 using PTZ coordinates PTZ_{A-1130}. PTZ_{A-1130} represents the PTZ coordinates of camera A 1150 looking at the first portion 1130 of the scene 1110. Camera B is looking at a second portion 1131 of the scene 1110 using PTZ coordinates PTZ_{B-1131}, camera C is looking at a third portion 1132 of the scene 1110 using PTZ coordinates PTZ_{C-1132}, and camera D is looking at a fourth portion 1133 of the scene 1110 using PTZ coordinates PTZ_{D-1133}.

Based on a predetermined criterion, one or more cameras are possible candidates for being the second camera to verify tampering at a given first camera. An example criterion to identify possible candidate cameras is that the maximum possible common field of view between a given camera and the candidate camera is higher than a predefined threshold value, say 80%. For example, in FIG. 11A, camera B is a candidate camera for camera A, because the overlapping field of view between the two cameras is larger than 80%. On the other hand, camera D is not a candidate camera for camera A, because the overlapping field of view between the two cameras is smaller than 80%, for example. A list containing the candidate camera information and relative PTZ coordinates are stored in the memory 106 for each camera. For example, the list stored for camera B is:

1. Camera A, PTZ_{A-1131}

2. Camera C, PTZ_{C-1131}

In one implementation, the relative PTZ coordinates for a candidate camera to have an overlapping field of view with the first camera (for example, PTZ_{A-1131} for the candidate camera A for the first camera B) are predetermined as part of the camera network setup process.

FIG. 11B is a flow diagram illustrating a method 1160 for performing the second camera selection step 522 of FIG. 5. The method 1160 begins at a Start step 1190 and proceeds to a first checking step 1161. In this checking step 1161, the processor 105 checks if, in the list of candidate cameras, there is a camera that has not been tested for suitability as the candidate “second camera” to a first camera that is suffering from tamper. If there is no camera available, No, the path NO is selected and control passes to step 1162. Step 1162 returns that no camera is selected as the second camera, control passes to an End step 1195 and the method 1160 terminates.

Returning to step 1161, if a camera is available in the list of cameras that is available for evaluation, Yes, the path YES is selected to go to camera evaluation step 1163. The camera evaluation step 1163 selects the available camera as the candidate camera and evaluates whether an occlusion has been detected in the candidate camera. The occlusion is detected using occlusion detection step 520 of the method 500. Control passes to a second decision step 1164, which checks whether occlusion is being detected. If occlusion is detected at the candidate camera, Yes, the path YES is selected and control passes from the second decision step 1164 to return to the first decision step 1161. If at the second decision step 1164 occlusion is not detected at the candidate camera, No, the path NO is selected and control passes from the second decision step 1164 to step 1165. Step 1165 selects the candidate camera as the second camera, control then passes to the End step 1195, and the method 1160 terminates.

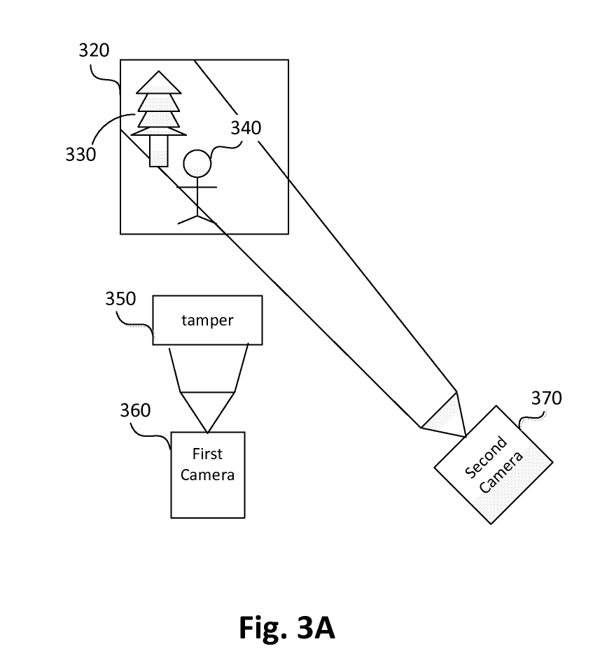

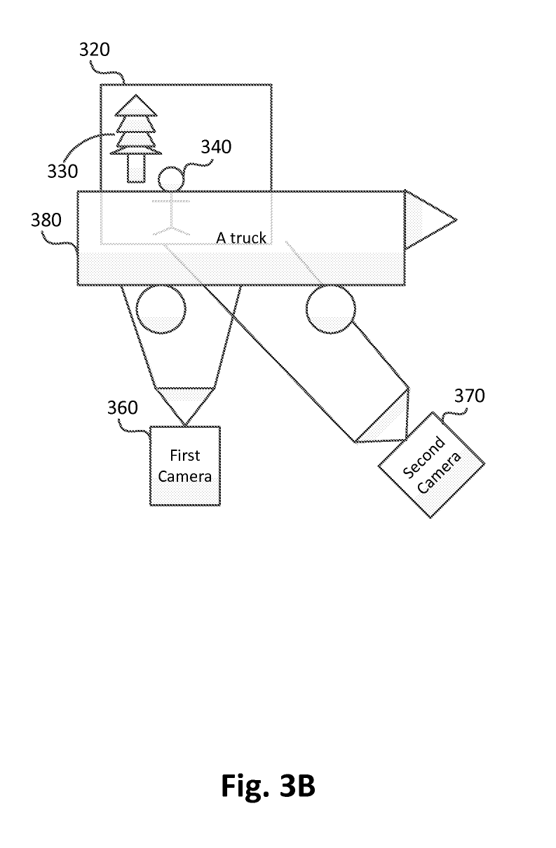

FIGS. 3A and 3B are schematic representations illustrating two scenarios in which an occlusion is detected at a first camera. FIGS. 3A and 3B show an object 320 representing a scene that includes a foreground object 340. The remaining region of the scene 320, including a tree, represents background 330. This information is stored in the scene model 1000. FIGS. 3A and 3B also show a first camera 360 and a second camera 370. The first camera 360 has a first field of view and the second camera 370 has a second field of view.

FIG. 3A shows a first scenario in which the first field of view of the first camera 360 is tampered. The tampering is shown by a blocking of the scene 320 by an object 350 in front of the first camera 360. Occlusion of the first field of view of the first camera 360 is detected. The second camera 370 is utilised to verify whether the occlusion relates to tampering of the first camera 360. In this scenario, the second field of view of the second camera 370 includes a portion of the scene 320 and overlaps with the first field of view of the first camera 360. An image captured by the second camera 370 is similar to the scene model 1000 for the scene 320 and hence tampering is verified.

FIG. 3B shows a second scenario in which a large object is positioned in front of the scene 320. In the example of FIG. 3B, the large object is a truck 380. As described above with reference to FIG. 3A, occlusion of the first field of view of the first camera 360 is detected. The second camera 370 is utilised to verify whether the occlusion relates to tampering of the first camera 360. In this second scenario, an image captured by the second camera 370 is different to the scene model 1000 of the scene 320 and hence, tampering at the first camera is not verified. In one embodiment, no tamper alert is generated for the scenario in FIG. 3B, as it is considered to be a false alarm.

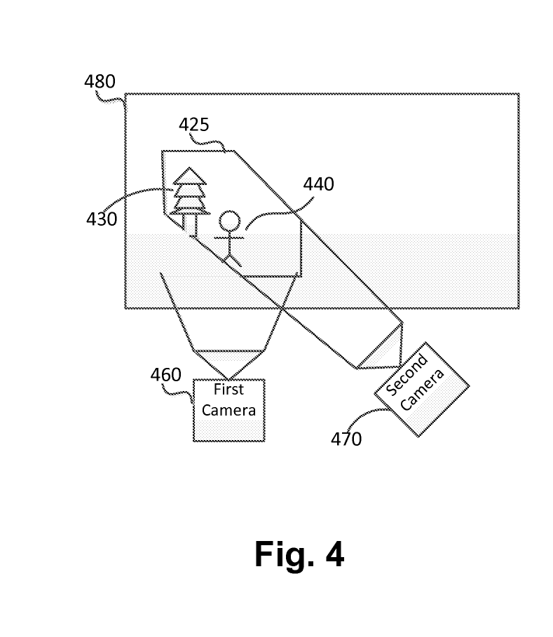

FIG. 4 is a schematic representation illustrating overlapping fields of view between a first camera 460 and a second camera 470. A scene 480 includes a foreground object 440, which in this example is a person. The remaining region of the scene 480, including a tree 430, represents background. This information is stored in a scene model associated with the scene 480. The first camera 460 has a first field of view and the second camera 470 has a second field of view. The first field of view and the second field of view overlap, wherein the overlapping field of view 425 includes the foreground object 440 and the background object 430. The overlapping field of view 425 indicates that both the first camera 460 and the second camera 470 are able to capture the background object 430 and the foreground object 440 from their view points.

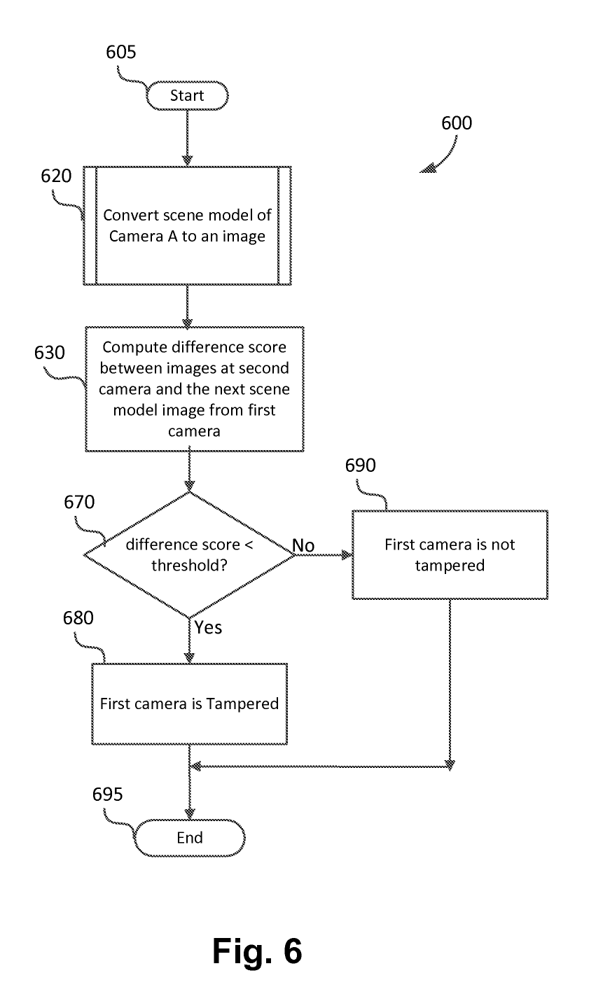

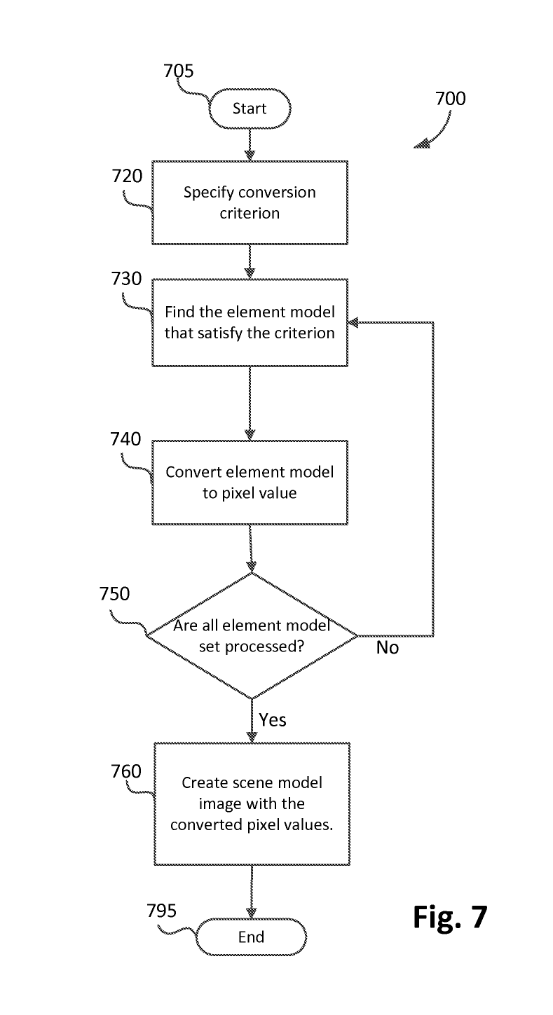

FIG. 6 is a flow diagram of a method 600 for determining if a first camera has been tampered with, as executed at step 570 of FIG. 5 and with reference to FIGS. 3A and 3B. The method 600 describes the exemplary embodiment of determining if tampering of the first camera 360 has occurred. The method 600 begins at a Start step 605 and proceeds to step 620, which generates an image representing the scene 320 before the occlusion event has occurred. The generated image is generated from the scene model associated with the first field of view of the scene 320, as captured by the first camera 360. Thus, the scene model is associated with the first camera 360. The scene model of the first field of view of the scene 320 may be stored in memory of the first camera 360 or alternatively may be stored elsewhere, such as on a database coupled to a camera network system that includes the first camera 360. The details of the process of generating an image from the scene model is described below with reference to FIG. 7.

Control passes from step 630 to step 630, which computes a difference score between an image captured by the second camera 370 of the scene 320 and the image generated from the scene model associated with the first camera. The difference may be computed, for example, by the processor 105 in the second camera 370. In one embodiment, the difference score is generated using feature points matching between two images. Harris-corner feature points are determined for each image. The feature points are described using a descriptor vector, which contains visual information in the neighbourhood of the feature point. An example of a descriptor vector is the Scaled Up Robust Feature (SURF) descriptor. The SURF descriptor represents visual information of a square region centred at the feature point and oriented in a specific orientation. The specific orientation is generated by detecting a dominant orientation of the Gaussian weighted Haar wavelet responses at every sample point within a circular neighbourhood around the point of interest. The square region oriented at the specific orientation is further divided regularly into smaller 4×4 square sub-regions. For each sub-region, a 4 dimensional vector using Gaussian weighted Haar wavelet responses are generated representing a nature of underlying intensity pattern in the sub-region. This gives a 64 dimension vector for a feature point.

The feature points from two images are matched by estimating a distance between the descriptor vectors of the two feature points using the following equation:

$$d = {\sum }_{i = 1}^{64} {( {D}_{{F}_{1}} ( i ) - {D}_{{F}_{2}} ( i ) )}^{2} \qquad Equation ( 1 )$$

where:

d represents a distance metric between two feature points,

D_{F}_{₁} and D_{F}_{₂} represent the descriptor of the two feature points F₁ and F₂, and

i represents the i^{th} value of the descriptor vector.

The distance metric shown by Equation (1) is also known as Sum of Square Difference score.

In the exemplary embodiment, a feature point F₁ located at coordinates (x, y) in the first image is identified. For example, the coordinates (x, y) are (100, 300). Then, the pixel at the same identified coordinates (x, y) is located in the second image to determine the feature points in the vicinity of this same coordinate in the second image. In other words, the location of the first feature points in the first image corresponds substantially to the location of the second feature point in the second image. In this example, the coordinates are (100, 300) in the second image. Next, a square region is defined, centred around the pixel location (x, y) in the second image. The size of the region is 100×100 pixels in the exemplary embodiment. The feature points in this determined square region are determined A distance score from the feature point in the first image is calculated for each of the set of feature points found in the second image within the square region. As mentioned before, the distance score is a metric of difference between a first set of characteristics of the feature point in the first image and a second set of characteristics of the feature point in the second image. The distance score for the selected feature point in the second image has the minimum distance of all distance scores of the feature point, as defined by the equation below:

d_{F}_{₁}=min(d₁,d₂, . . . ,dₖ) Equation (2)

where:
d_{F}_{₁} represents the distance score for feature point F₁ of the first image,
d₁, d₂, . . . , dₖ represents distance score of the feature point F₁ with the k feature points in the pre-defined region in the second image, and
k represents the number of feature points in the predefined region in the second image.

The sum of differences score for all features points in the first image is termed as the difference score between two images, as defined by the equation below:

$${D}_{{I}_{1} , {I}_{2}} = {\sum }_{n = 1}^{N} {d}_{{F}_{n}} \qquad Equation ( 3 )$$

where:
D_{I}_{₁}_{,I}_{₂} represents the difference score between the first and the second image,
N represents the total number of feature points in the first image, and
d_{F}_{ₙ} represents the distance score of n^{th} feature point in the first image calculated using Equation (1) and Equation (2).

An alternative embodiment utilises Scale Invariant Feature Transform (SIFT) feature points. SIFT feature points are relatively robust to view point changes. A yet further embodiment utilises Scaled Up Robust Feature (SURF) feature points. The selection of a particular feature point method depends on the differences in the view points of two cameras. If the two cameras have similar view points, Harris-corner based feature points are sufficient to match two images. For larger view-point differences, other feature points that are robust to large view-points changes, such SIFT or SURF, are used.

Returning to FIG. 6, control passes from step 630 to decision step 670, which compares the difference score calculated at the computing step 630 with a predetermined threshold value to determine whether the difference score is a low difference score (less than the threshold) or a high difference score (higher than the threshold). In this example, the predefined threshold is set to 80 Luma² (where Luma represent the luminance intensity for 8 bit input images).

If the final difference score is less than the threshold value, Yes, then a low difference score is obtained and the method 600 proceeds from step 670 to step 680. A low difference score suggests that the scene as captured by the second camera 370 is similar to the scene captured by the first camera 360 before the occlusion and hence, the first camera 360 is declared to be tampered. Step 680 declares the first camera 360 as tampered, control passes to step 695 and the method 600 terminates.

Returning to step 670, if the final difference score is greater than the threshold value, No, then a high difference score is obtained and the method 600 proceeds from step 670 to step 690. A high difference score suggests that the scene as captured by the second camera 370 is not similar to the scene captured by the first camera 360 before the occlusion. Thus, the chances are high that either the scene has changed significantly or there is a different object such as truck 380 in front of both the first and second cameras 360, 370. In this scenario, step 690 declares the first camera 360 as not tampered, control passes to step 695 and the method 600 terminates.

In an alternative embodiment, multiple images are generated in step 620 by using multiple conversion criteria. One image is generated by selecting an element model that has the maximum number of hit counts among all element models in the element model set for each block. Another image is generated by selecting an element model that has the oldest creation time in the element model set among all element models for each block. Thus, multiple images are generated from the scene model. A difference score is calculated for each image generated from the scene model and the input image at the second camera, by using the method of step 630. In one embodiment, the final difference score between the scene model associated with the first camera and the input image from the second camera is calculated by using the minimum of all the difference scores corresponding to the multiple images generated from the scene model. In another embodiment, the average of all the difference scores corresponding to the multiple images from the scene model is used as the final difference score. The method of generating multiple images from the scene model has the advantage of being robust against some changes in the scene itself between the time occlusion is detected and the time the first image of the scene is captured by the second camera 370.

The final difference score is used in method 600 at step 670 to determine if the first camera is tampered or not.

FIG. 7 is a flow diagram illustrating a method 700 for generating one image by processing all the element model sets 1010 from the scene model. The method 700 begins at a Start step 705 and proceeds to a selection rule specifying step 720. The rule specifying step 720 specifies a selection rule for selecting an element model from an element model set. In one embodiment, the selection rule is to select an element model that has the maximum value within the element model set for the temporal characteristic “hit count”. In another embodiment, the selection rule is set to selecting an element model that has the oldest creation time.

Control passes from step 720 to a searching step 730, in which the processor 105 goes through each element model in the current element model set. Step 730 selects the element model that satisfies the selection rule, for conversion step 740.

In conversion step 740, the processor 105 converts the selected element model to a pixel value. In one embodiment, in which the element model stores the DCT values of a block of pixels, step 740 utilises a reverse DCT process to calculate a pixel value of the block. This process of transforming an element model from the DCT domain to the pixel value domain is referred to as a scene model to image transformation.

Control passes from step 740 to a decision step 750, in which the processor 105 examines if all element model sets of the scene model have been processed. If not all element model sets have been processed, No, the method 700 loops back to the searching step 730 and reiterates through steps 730, 740, and 750 until all element model sets of the scene model have been processed. If step 750 determines that all element model sets have been processed, Yes, control passes from step 750 to step 760, in which the processor 105 creates an image with the converted pixel values. Control passes from step 760 to an End step 795 and the method 700 terminates.

In the exemplary embodiment, a subset of the scene model 1000 is used to generate the image from the scene model. In another embodiment, a checker board pattern is followed to select the subset, where the odd columns in the odd rows are used and the even columns in the even rows are used. In another embodiment, the subset is selected based on characteristics of the element models. For each element model set, an inclusion flag is initialised to false. If there is an element model in an element model set with a “hit count” that is a constant, say 200 frames, greater than the “hit count” of the element model 1020 with the second greatest “hit count” in the element model set 1010, the inclusion flag is set to true. The subset consists of the element model sets 1010 with an inclusion flag set to true.

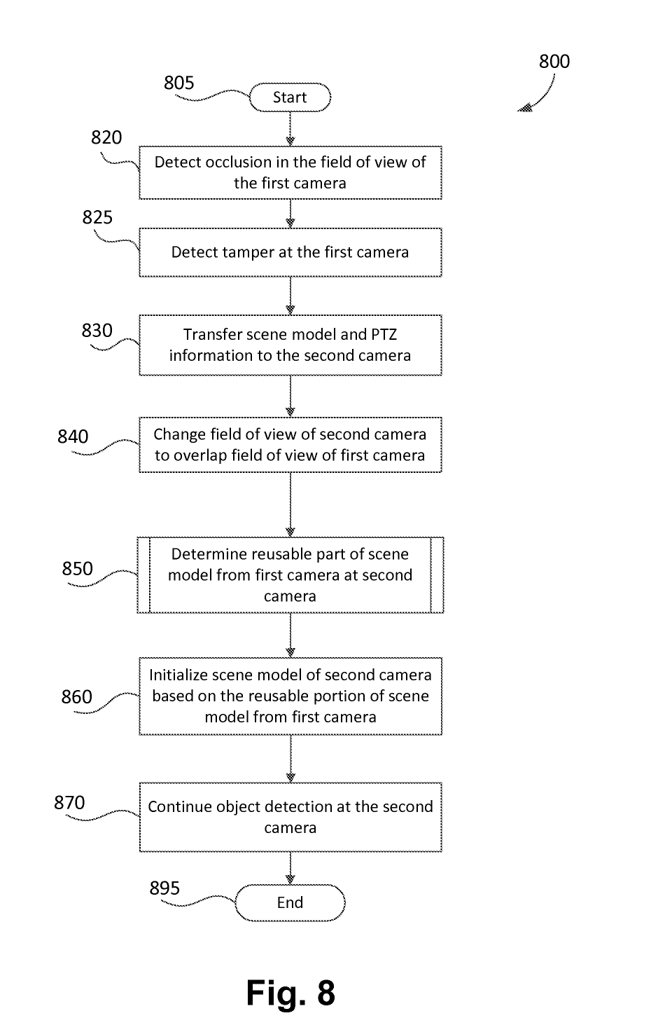

FIG. 8 is a flow diagram illustrating a method 800 for continuing object detection at the selected second camera 370 by reusing part of the scene model 1000 associated with the first camera 360, when tampering is detected at the first camera. The method 800 will now be described with reference to FIG. 3A. The method 800 begins at a Start step 805 and proceeds to a detecting step 820. Step 820 detects occlusion in the first field of view of the first camera. The step 820 corresponds to step 520 in FIG. 5.

Control passes from step 820 to step 825, which selects the second camera 370 to verify tampering at the first camera 360. In one implementation, the processor 105 of the second camera 370 uses method 500 to detect tampering at the first camera 360. When tampering is confirmed, the method 800 proceeds from step 825 to a transferring step 830.

The transferring step 830, transfers the scene model 1000 and calibration information via the communication network 114 to the second camera 370. The calibration information includes, for example, but is not limited to, the focus length and zoom level of the first camera 360. In one implementation, the processor 105 of the first camera 360 manages the transfer. In another implementation, the scene model and calibration information are transferred from a server, database, or memory. The transferring step 830 corresponds to step 530 of FIG. 5. At step 840, the second camera 370 changes its field of view, via pan tilt controller 114 to the scene 320, such that the changed field of view of the second camera overlaps with the first field of view of the first camera 360.

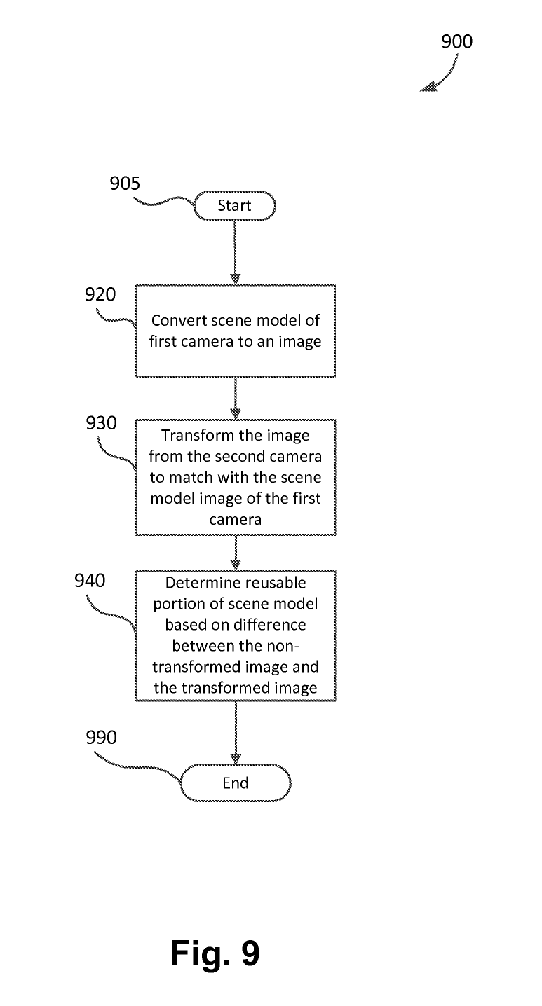

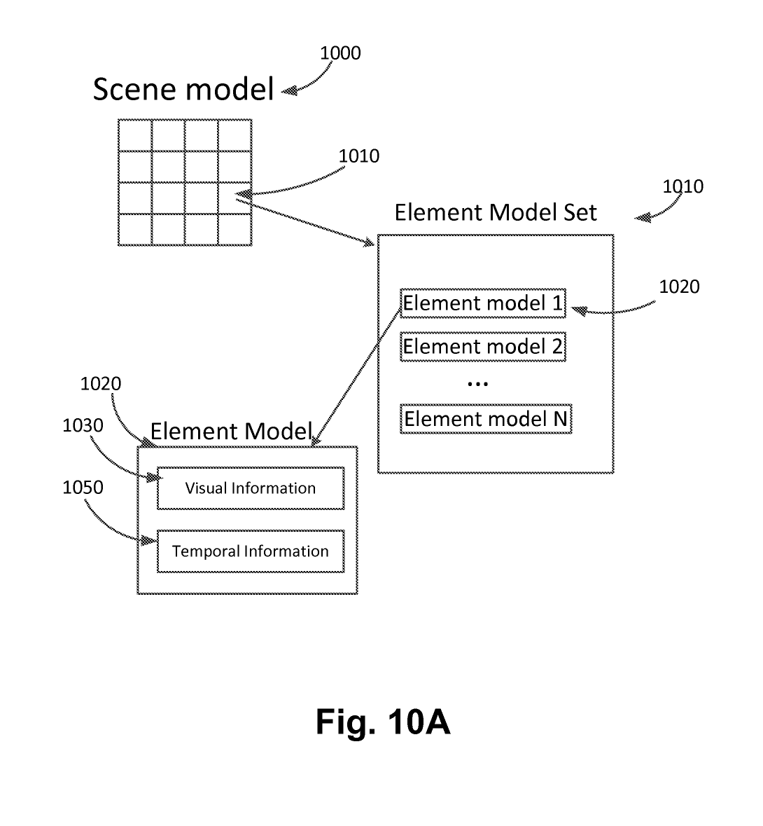

Control passes from step 840 to step 850, which determines a reusable part of the scene model associated with the first camera 360. Further detail of step 850 is described below with reference to FIG. 9. After the reusable part of the scene model is determined by the processor 105 of the second camera 370 in step 850, control passes to step 860, which initialises a scene model associated with the second camera at the changed field of view using the reusable part of the scene model from the first camera 360. By reusing the scene model 1000 associated with the first camera 360, the second camera 370 has historical information about the overlapping field of view of the scene 320 and thus continues foreground detection immediately without requiring further initialisation.

In one embodiment, for each of the reusable part of the scene model from the first camera determined in step 850, a copy of the element model set at the corresponding location of the scene model associated the second camera 370 is made; in this embodiment, the rest of the scene model is initialised with the first image captured by the second camera 370 of the changed field of view. Next, the second camera starts object detection 870 of the scene 320 using the newly initialised scene model at step 860.

FIG. 9 is a flow diagram of a method 900 for computing a reusable part of a scene model associated with a first camera, as executed at step 850 of FIG. 8. The method 900 will now be described with reference to FIG. 7 and FIG. 8. In one embodiment, the method 900 is implemented as one or more code modules of the firmware resident within the memory 106 of the camera system 100 and being controlled in its execution by the processor 105.

The method 900 begins at a Start step 905 and proceeds to a converting step 920, in which the processor 105 uses the method 700 to perform the step of converting the scene model 1000 of the first camera 360 to an image. In one embodiment, the conversion is based on the element model in the element model set with the highest number of hit count. In another embodiment, the element model 1020 with the oldest creation time from each element model set 1010 is selected.

Then at the transforming step 930, the image captured from the second camera 370 is transformed to match with the generated scene model image 760 for the purpose of finding the overlapping region between the two images. In one embodiment, homographic transformation is performed using Equation (4) as follows:

$$( \begin{matrix}{x}_{1} \\ {y}_{1} \\ 1\end{matrix} ) = [ \begin{matrix}{h}_{11} & {h}_{12} & {h}_{13} \\ {h}_{21} & {h}_{22} & {h}_{23} \\ {h}_{31} & {h}_{32} & 1\end{matrix} ] ( \begin{matrix}{x}_{2} \\ {y}_{2} \\ 1\end{matrix} ) \qquad Equation ( 4 )$$

Equation (4) shows the mapping between a coordinate (x₁, y₁) from one image to the coordinate of another image through the transformation matrix

$$[ \begin{matrix}{h}_{11} & {h}_{12} & {h}_{13} \\ {h}_{21} & {h}_{22} & {h}_{23} \\ {h}_{31} & {h}_{32} & 1\end{matrix} ] .$$

To find the values of h₁₁ to h₃₂ in the transformation matrix, a minimum of four corresponding feature points are found from each of the above mentioned images. For a given feature point F₁ in the first image, the corresponding feature point in the second image is the feature point that gives the minimum distance score found in Equation (2). After the corresponding feature points are located, the singular value decomposition method is used to determine the values of h₁₁ to h₃₂. In one embodiment, the coordinates of corresponding feature points from the two images are obtained using Harris point corner detection method.

Control passes from step 930 to a determining step 940. Based on the mapping found from step 930, the processor 105 of the second camera 370 computes the overlapping region of the transformed image and the generated scene model image. In one embodiment, each pixel in the overlapping region is mapped back to the corresponding location of the original scene model image of the first camera 360. This way, the overlapping region of the original model image is determined. Next, the overlapping region of the original model image is mapped to the corresponding location of element model set in the scene model of the first camera 360. This overlapping region indicates the part of the scene model of the first camera 360 that can be reused by the second camera 370. Control passes from step 940 to an End step 990 and the method 900 terminates.

Using a second camera 370 on demand to differentiate tamper and occlusion at the field of view of the first camera is advantageous over constantly using a redundant camera. On a site that is covered by multiple cameras, this reduces the number of cameras needed for video surveillance by up to 50%. Another advantage is created by the possibility of continuing object detection by the second camera 370 reusing the scene model 1000 from the first camera. This reduces the initialisation time of object detection and the dependent video analytics applications to zero in parts of the image where the scene model 1000 is reused. Although an initialisation time is usually acceptable in surveillance scenarios, because cameras typically run for weeks or months after the initialisation, in the scenario of tampering it is imperative to apply object detection and video analytics as soon as possible, and preferably immediately, as there is a high risk of a security threat.

### INDUSTRIAL APPLICABILITY

The arrangements described are applicable to the computer and data processing industries and particularly for the video and security industries.

The foregoing describes only some embodiments of the present invention, and modifications and/or changes can be made thereto without departing from the scope and spirit of the invention, the embodiments being illustrative and not restrictive.

We claim:

1. A method for detecting tampering of a first camera in a camera network system, the first camera being adapted to capture a scene in a first field of view, said method comprising:
detecting an occlusion of the scene in the first field of view;
changing a second field of view of a second camera to overlap with the first field of view of the first camera in response to the detected occlusion; and
transferring a background model of the scene in the first field of view of the first camera to the second camera.

2. The method according to claim 1, further comprising:
transforming a background model of a portion of the scene in the field of view of the first camera to obtain a set of reference images relating to the field of view of the first camera.

3. The method according to claim 2, further comprising:
determining a difference between an image captured by the second camera of the changed field of view and the set of reference images relating to said field of view of the first camera; and
detecting tampering of the first camera based on the difference exceeding a predefined threshold.

4. The method according to claim 3, wherein said step of determining the difference comprises:
determining a first feature point in at least one reference image of the set of reference images;
determining a second feature point in the image captured by the second camera of said changed field of view of said second camera; and
computing a distance score between the first feature point and the second feature point to determine the difference.

5. The method according to claim 4, wherein said first feature point and said second feature point correspond to a substantially same location in the scene.

6. The method according to claim 2, wherein the set of reference images and the background model of the scene in the field of view of the first camera are stored in a memory of the first camera.

7. The method according to claim 2, wherein the set of reference images and the background model of the scene in the field of view of the first camera are stored on a server coupled to each of the first camera and the second camera.

8. The method according to claim 1, further comprising:
selecting the second camera based on the changed field of view of the second camera overlapping a predetermined threshold portion of the first field of view of the first camera.

9. A method for detecting a foreground object in an image sequence, comprising:
detecting a foreground object in a first image associated with a first field of view of a first camera, using a scene model associated with the first field of view of the first camera;
transferring to a second camera a background model associated with the first field of view of the first camera and calibration information associated with the first camera;
determining a reusable part of the background model associated with said first field of view of the first camera, based on the calibration information associated with the first camera;
changing a field of view of the second camera to overlap the first field of view of the first camera; and
detecting the foreground object in a second image associated with the changed field of view of the second camera, based on the determined reusable part of the background model.

10. The method according to claim 9, further comprising:
detecting an event at the first camera, based on the detected foreground object, wherein the transferring of the background model is in response to the detecting.

11. The method according to claim 9, wherein said calibration information includes a position of said first camera.

12. The method according to claim 11, wherein said calibration information includes a set of parameters for the first camera.

13. The method according to claim 12, wherein said set of parameters includes Pan-Tilt-Zoom (PTZ) coordinates for said first camera.

14. The method according to claim 9, wherein said background model is stored on one of said first camera and a server coupled to each of said first camera and said second camera.

15. A camera network system for monitoring a scene, said system comprising:
a first camera having a first field of view;
a second camera having a second field of view;
a memory for storing a background model associated with a portion of a scene corresponding to said first field of view of said first camera;
a storage device for storing a computer program; and
a processor for executing the program, said program comprising:
code for detecting an occlusion of the scene in the first field of view of the first camera;
code for changing the second field of view of the second camera to overlap with the first field of view of the first camera in response to the detected occlusion; and
code for transferring a background model of the scene in the first field of view of the first camera to the second camera.

16. The system according to claim 15, wherein the program further comprises:
code for transforming a background model of a portion of the scene in the field of view of the first camera to obtain a set of reference images relating to the field of view of the first camera

17. The system according to claim 16, wherein the program further comprises:
code for determining a difference between an image captured by the second camera of said changed field of view and a set of reference images relating to said first field of view of said first camera; and
code for detecting tampering of said first camera based on said difference exceeding a predefined threshold.

18. The system according to claim 15, wherein said storage device and processor are located on a server coupled to each of said first camera and said second camera.

19. The system according to claim 15, wherein first camera is a Pan-Tilt-Zoom (PTZ) camera that includes said memory, wherein said memory further stores said set of reference images and calibration information relating to said first camera.

20. A method for detecting tampering of a first camera in a camera network system, said first camera being adapted to capture a portion of a scene in a first field of view of the first camera, said method comprising:
detecting an occlusion of the scene in the first field of view of the first camera;
changing a field of view of a second camera to overlap with the first field of view of the first camera in response to the detected occlusion;
determining a difference between an image captured by the second camera with said changed field of view and a reference image relating to the first field of view of said first camera; and
detecting tampering of said first camera based on the determined difference exceeding a predefined threshold.
